(19) United States
(12) Patent Application Publication
(10) Pub. No.: US 2019/0249829 A1
(43) Pub. Date: Aug. 15, 2019

(54) LIQUEFIED GAS REGASIFICATION SYSTEM AND OPERATION METHOD THEREFOR

(71) Applicant: DAEWOO SHIPBUILDING & MARINE ENGINEERING CO., LTD., Geoje-si, Gyeongsangnam-do (KR)

(72) Inventors: Su Kyung AN, Gwangmyeong-si (KR); Du Hyeon CHO, Siheung-si (KR)

(21) Appl. No.: 16/342,881

(22) PCT Filed: Oct. 18, 2017
(86) PCT No.: PCT/KR2017/011523

§ 371 Date: Apr. 17, 2019

(30) Foreign Application Priority Data
Oct. 19, 2016 (KR) 10-2016-0135554

(51) Int. Cl. F17C 9/02; F17C 13/04

(52) U.S. Cl. CPC F17C 9/02; F17C 13/04; F17C 2221/033; F17C 2223/0161; F17C 2265/05; F17C 2227/0135; F17C 2250/0408; F17C 2250/0626; F17C 2227/0393

(57) ABSTRACT

A liquefied gas regasification system and a method of operating the same, and, more particularly to a liquefied gas regasification system which can smoothly supply re-gasified liquefied gas to a gas consumer, and a method of operating the same are disclosed. The liquefied gas regasification system includes: a supply pump discharging liquefied gas from a liquefied gas storage tank; a high-pressure pump receiving liquefied gas from the liquefied gas storage tank and compressing the liquefied gas; and a fourth liquefied gas supply line connecting the supply pump to the high-pressure pump, wherein the supply pump is directly connected to the high-pressure pump through the fourth liquefied gas supply line, such that liquefied gas is directly supplied to the high-pressure pump by the supply pump.

### TECHNICAL FIELD

The present invention relates to a liquefied gas regasification system and a method of operating the same, and, more particularly, to a liquefied gas regasification system which can smoothly supply regasified liquefied gas to a gas consumer and a method of operating the same.

### BACKGROUND ART

Generally, natural gas is cryogenically liquefied into Liquefied Natural Gas (LNG) at the place of production and then transported to a distant destination by an LNG carrier. LNG is obtained by liquefying natural gas to about −163° C. at normal pressure and has a volume of about 1/600 that of natural gas in gaseous state. Thus, LNG is suited to long distance transport by sea.

An LNG carrier is intended to carry LNG to an onshore source of demand and is thus provided with an LNG storage tank that enables LNG to be kept in a cryogenic state. Generally, LNG in a liquefied state is unloaded from the LNG carrier to an onshore terminal. The unloaded LNG is regasified by an LNG regasification facility installed at the onshore terminal and then supplied to a consumer.

Such an LNG regasification facility is economically advantageous when provided to a stable source of demand where a strong natural gas market is created. However, installation of the LNG regasification facility at a source of demand where natural gas demand is limited to a specific season, term or period is economically disadvantageous due to high installation and operating costs.

Particularly, a typical LNG regasification facility at an onshore terminal cannot provide regasification of LNG when damaged or destroyed by a natural disaster.

Accordingly, there have been developed LNG regasification vessels (LNG RVs), that is, LNG carriers provided with an LNG regasification system, or floating storage and regasification units (FSRUs) in order to regasify LNG at sea and supply natural gas to onshore terminals.

In an LNG RV or an LNG FSRU, LNG in an LNG storage tank is supplied to a vaporizer to be regasified. Here, the LNG is supplied to the vaporizer using a high-pressure pump.

The high-pressure pump includes a cylindrical housing which is connected at a lower portion thereof to an LNG suction line allowing LNG to be drawn into the high-pressure pump therethrough and is connected at an upper portion thereof to an LNG discharge line allowing LNG to be discharged to the vaporizer therethrough. In addition, the housing is provided therein with a pumping chamber for suctioning LNG to increase the pressure of the LNG, wherein the pumping chamber is provided therein with components such as a motor, an impeller and the like. The motor has a shaft extending toward a bottom of the pumping chamber and the impeller is integrated with the motor bottom side of the shaft. The impeller serves to compress LNG suctioned into the housing from the LNG storage tank through the LNG suction line to high pressure. LNG having been compressed to high pressure by the impeller is discharged to the vaporizer through the LNG discharge line at the upper portion of the housing.

In such a high-pressure pump, LNG in the housing is likely to be vaporized due to heat from the motor or the outside, causing generation of boil-off gas. If boil-off gas generated in the high-pressure pump cannot be discharged smoothly, the pressure inside the high-pressure pump rises. When the pressure in the high-pressure pump is excessively high, LNG cannot be introduced into the high-pressure pump, the level of LNG in the high-pressure pump can be sharply reduced below the minimum level for operation of the high-pressure pump. As a result, “pump trip”, that is, failure of the high-pressure pump, is likely to occur, causing the inability to supply a required amount of LNG to a gas consumer.

### DISCLOSURE

### Technical Problem

Embodiments of the present invention have been conceived to solve such problems in the art and it is an aspect of the present invention to provide a liquefied gas regasification system which can smoothly supply natural gas from a liquefied gas storage tank to a gas consumer without shutdown of a high-pressure pump, and a method of operating the same.

### Technical Solution

In accordance with one aspect of the present invention, a liquefied gas regasification system includes: a supply pump discharging liquefied gas from a liquefied gas storage tank; a high-pressure pump receiving liquefied gas from the liquefied gas storage tank and compressing the liquefied gas; and a fourth liquefied gas supply line connecting the supply pump to the high-pressure pump, wherein the supply pump is directly connected to the high-pressure pump through the fourth liquefied gas supply line, such that liquefied gas is directly supplied to the high-pres sure pump by the supply pump.

Preferably, the liquefied gas regasification system further includes: a suction drum recovering boil-off gas generated in the high-pressure pump; and a first boil-off gas discharge line connecting the high-pressure pump and the suction drum, such that boil-off gas generated in the high-pressure pump is discharged to the suction drum through the first boil-off gas discharge line.

Preferably, the liquefied gas regasification system further includes: a second liquefied gas supply line connecting the suction drum to the high-pressure pump; and a sixth valve disposed on the second liquefied gas supply line and controlled based on a measured value of level of liquefied gas in the suction drum, such that liquid accumulated in the suction drum is supplied to the high-pressure pump.

Preferably, the liquefied gas regasification system further includes: a first liquefied gas supply line connecting the supply pump to the suction drum, such that liquefied gas suctioned by the supply pump is supplied to the suction drum.

Preferably, the liquefied gas regasification system further includes: a vaporizer vaporizing liquefied gas compressed by the high-pressure pump and supplying the vaporized liquefied gas to a gas consumer.

In accordance with another aspect of the present invention, a method of operating a liquefied gas regasification system includes: supplying liquefied gas from a liquefied gas storage tank to a high-pressure pump and compressing, by the high-pressure pump, the liquefied gas; and supplying the compressed liquefied gas to a vaporizer, vaporizing, by the vaporizer, the compressed liquefied gas, and supplying the vaporized liquefied gas to a gas consumer, wherein liquefied gas is supplied directly to the high-pressure pump using a supply pump in the liquefied gas storage tank along a line directly connecting the supply pump to the high-pressure pump.

Preferably, boil-off gas generated in the high-pressure pump is discharged to a suction drum, and liquefied gas is supplied to the suction drum using the supply pump, such that liquid accumulated in the suction drum is supplied to the high-pressure pump.

Preferably, a portion of liquefied gas supplied using the supply pump is delivered to the suction drum to recondense boil-off gas returned to the suction drum, and the rest of the liquefied gas is delivered to the high-pressure pump along a line directly connecting the supply pump to the high-pressure pump.

Preferably, the liquid supplied from the suction drum to the high-pressure pump is delivered by head of liquid in the suction drum, and the liquefied gas supplied from the supply pump to the high-pressure pump is delivered by pressure of liquefied gas compressed by the supply pump.

Preferably, a level of liquid in the suction drum is higher than or equal to a predetermined value, a line connecting the suction drum to the high-pressure pump is opened.

### Advantageous Effects

According to the present invention, it is possible to overcome the inability to supply liquefied gas to a high-pressure pump due to pressure increase in the high-pressure pump caused by generation of boil-off gas.

In addition, according to the present invention, the boil-off gas in the high-pressure pump can be smoothly discharged and the minimum operable LNG level of the high-pressure pump can be maintained.

Further, according to the present invention, the boil-off gas discharged from the high-pressure pump can be recovered without waste.

Particularly, according to the present invention, it is possible to overcome the inability to supply liquefied gas from a storage tank to a suction drum due to pressure increase in the suction drum caused by excessive generation of boil-off gas during cooldown of the high-pressure pump or normal operation of a regasification system and the inability to supply liquefied gas from the suction drum to the high-pressure pump caused thereby.

Further, according to the present invention, liquefied gas can be supplied directly to the high-pressure pump using a liquefied gas supply pump, thereby overcoming the inability to supply liquefied gas from the suction drum to the high-pressure pump due to excessive generation of boil-off gas in the high-pressure pump.

Further, according to the present invention, net positive suction head (NPSH) of the high-pressure pump can be easily secured.

### DESCRIPTION OF DRAWINGS

FIG. 1 is a schematic block diagram of a liquefied gas regasification system according to one embodiment of the present invention.

### BEST MODE

The above and other aspects, features, and advantages of the present invention will become apparent from the detailed description of the following embodiments in conjunction with the accompanying drawings.

Hereinafter, embodiments of the present invention will be described in detail. It should be noted that like components will be denoted by like reference numerals throughout the specification. In addition, it should be understood that the present invention is not limited to the following embodiments and may be embodied in different ways.

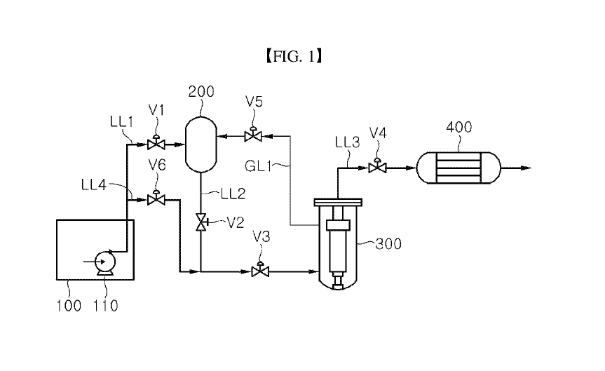

FIG. 1 is a schematic block diagram of a liquefied gas regasification system according to one embodiment of the present invention. Now, a liquefied gas regasification system according to this embodiment of the present invention and a method of operating the same will be described with reference to FIG. 1.

Herein, “liquefied gas” may refer to liquefied natural gas (hereinafter, “LNG”) and the liquefied gas regasification system may be used in supplying regasified liquefied gas from ships or offshore structures such as LNG RVs or FSRUs to sources of demand for gas, such as onshore facilities or other ships, without being limited thereto.

In addition, first to sixth valves, a supply pump, and the like described below may be controlled by a controller (not shown), or may be set to be automatically controlled according to a set value.

Referring to FIG. 1, the liquefied gas regasification system according to this embodiment of the present invention includes a vaporizer 400, which regasifies LNG stored in an LNG storage tank 100 and supplies the regasified LNG to a gas consumer (not shown).

In addition, the liquefied gas regasification system according to this embodiment further includes a high-pressure pump 300, as shown in FIG. 1. The high-pressure pump 300 serves to compress LNG to high pressure and supply the compressed LNG to the vaporizer 400 and includes a vertical cylindrical housing which contains a motor, an impeller and the like and into which LNG to be compressed is supplied.

For normal operation of the high-pressure pump 300, LNG in the housing needs to be kept at or above a predetermined level. LNG suctioned into the high-pres sure pump 300 is vaporized by heat from the motor, the impeller and the like or heat from the outside, such that an upper portion of the housing is filled with boil-off gas. Boil-off gas generated in the high-pressure pump 300 or introduced from the outside is discharged to the outside of the high-pressure pump 300 along a first boil-off gas discharge line GL1.

As used herein, the term “high pressure” means a pressure higher than the pressure of LNG suctioned by a supply pump 110 and may refer to the pressure of LNG discharged from the high-pressure pump 300 or the LNG supply pressure required by the vaporizer 400. Thus, “high pressure” does not necessarily correspond to a high pressure that is normally defined in the art, but may be a relative concept.

LNG stored in the LNG storage tank 100 is suctioned by the supply pump 110 and then supplied to the high-pressure pump 300 along a first liquefied gas supply line LL1 and a second liquefied gas supply line LL2. Then, LNG having been compressed by the high-pressure pump 300 is supplied to the vaporizer 400 along a third liquefied gas supply line LL3.

The vaporizer 400 vaporizes LNG and supplies the vaporized LNG to a gas consumer. Here, as a heat source for vaporizing LNG in the vaporizer 400, for example, steam, seawater, or glycol water may be used.

The supply pump 110 may be a submerged pump placed in the LNG storage tank 100, as shown in FIG. 1. The first liquefied gas supply line LL1 may be connected with a suction drum 200 holding LNG supplied from the supply pump 110 on a temporary basis prior to supply to the high-pressure pump 300.

LNG supplied from the suction drum 200 to the high-pressure pump 300 is delivered along the second liquefied gas supply line LL2 by pressure difference between the suction drum 200 and the high-pressure pump 300 or head of the suction drum 200. Thus, preferably, the suction drum 200 is disposed at a higher position than the high-pressure pump 300 and the second liquefied gas supply line LL2 connected to the high-pressure pump 300 extends from a bottom of the suction drum 200.

Generally, the supply pump 110 disposed in the liquefied gas storage tank 100 is a fixed capacity pump in which the suction flow rate or discharge flow rate by each pumping action is fixed, and the amount of LNG to be vaporized by the vaporizer 400 depends on the demand of a gas consumer.

When there is demand for vaporization of LNG in the vaporizer 400, the supply pump 110 is operated to suction LNG in the LNG storage tank 100 and then LNG discharged from the supply pump 110 is supplied to the suction drum 200 along the first liquefied gas supply line LL1.

A first valve V1 may be provided on the first liquefied gas supply line LL1 for controlling opening/closing of the first liquefied gas supply line LL1. Upon operation of the supply pump 110, the first valve V1 is controlled to be opened such that LNG suctioned by the supply pump 110 and discharged from the supply pump 110 can be delivered to the suction drum 200 along the first liquefied gas supply line LL1.

Although the first liquefied gas supply line LL1 is shown as provided with one first valve V1 in FIG. 1, it is desirable that a plurality of first valves V1 having the same sizes be arranged in parallel on the first liquefied gas supply line LL1. When the plurality of first valves V1 is provided, all of the first valves may be controlled to be opened/closed to adjust the flow rate of LNG into the suction drum 200 along the first liquefied gas supply line LL1, or some of the first valves may be controlled to serve as a redundant valve.

As such, the flow rate of LNG into the suction drum 200 or the level of LNG in the suction drum 200 may be controlled by controlling the first valve V1. Control of the level of LNG in the suction drum 200 allows the internal pressure of the suction drum 200 to be kept at or above a predetermined level, such that LNG can be smoothly supplied from the suction drum 200 to the high-pressure pump 300. Here, the internal pressure of the suction drum 200 is preferably kept at a higher level than the internal pressure of the LNG storage tank 100.

The level of LNG in the suction drum 200 may be controlled based on measurement of the LNG level in the suction drum 200 or the measurement of the flow rate of LNG into or out of the suction drum 200. Alternatively, the level of LNG in the suction drum 200 may be controlled based on the measurement of the flow rate of boil-off gas re into the suction drum 200, which will be described below.

The suction drum 200 receives LNG from the supply pump 110 through the first liquefied gas supply line LL1 and supplies LNG to the high-pressure pump 300 through the second liquefied gas supply line LL2.

A second valve V2 may be provided on the second liquefied gas supply line LL2 for controlling opening/closing of the second liquefied gas supply line LL2 and the flow rate of LNG through the second liquefied gas supply line LL2. A degree of opening of the second valve V2 may be controlled based on the LNG level in the suction drum 200 or the flow rate of LNG required by the vaporizer 400.

Preferably, the second liquefied gas supply line LL2 is connected to a lower portion of the high-pressure pump 300, such that LNG supplied from the suction drum 200 to the high-pressure pump 300 along the second liquefied gas supply line LL2 can initially fill the lower portion of the high-pressure pump 300. The high-pressure pump 300 compresses LNG to high pressure and discharges the compressed LNG to the third liquefied gas supply line LL3 connected to the vaporizer 400 through an upper side of the high-pressure pump 300.

High-pressure LNG discharged from the high-pressure pump 300 is supplied to the vaporizer 400 along the third liquefied gas supply line LL3, and a fourth valve V4 may be provided on the third liquefied gas supply line LL3 for controlling opening/closing of the third liquefied gas supply line LL3 and the flow rate of LNG through the third liquefied gas supply line LL3. The fourth valve V4 may be controlled based on the flow rate of LNG required by the vaporizer 400.

In addition, the liquefied gas regasification system according to this embodiment includes a first boil-off gas discharge line GL1 connecting the high-pressure pump 300 to the suction drum, as shown in FIG. 1, such that boil-off gas can be discharged from the high-pressure pump 300 through the first boil-off gas discharge line GL1, thereby securing the operable LNG level of the high-pressure pump 300.

As described above, LNG in the high-pressure pump 300 can be vaporized to generate boil-off gas, causing pressure increase in the high-pressure pump 300. When the pressure in the high-pressure pump 300 rises due to boil-off gas, LNG cannot be delivered from the suction drum 200 to the high-pressure pump 300 by head of the suction drum 200. As a result, the LNG level in the high-pressure pump 300 sharply decreases, causing failure of the high-pressure pump 300, such as a pump trip.

In other words, the regasification system according to this embodiment includes the first boil-off gas discharge line GL1 connecting the high-pressure pump 300 to the suction drum 200 such that boil-off gas can be discharged from the high-pressure pump 300 through the first boil-off gas discharge line GL1, whereby the minimum operable LNG level of the high-pressure pump 300 can be maintained.

Herein, the term “minimum operable LNG level” refers to a level of LNG in the housing of the high-pressure pump 300 at or above which the high-pressure pump 300 is operable without cavitation or pump trip and may be preset by an operator depending on operation conditions or the like or may be predetermined during design or manufacture of the high-pressure pump 300.

The first boil-off gas discharge line GL1 extends from an upper portion of the high-pressure pump 300, preferably, an upper side surface of the high-pressure pump 300 above a portion of the high-pressure pump corresponding to the minimum operable LNG level of the high-pressure pump 300, and is connected to an upper side surface of the suction drum 200, such that boil-off gas in the high-pressure pump 300 can be discharged to the first boil-off gas discharge line GL1 and returned to the suction drum 200.

As described above, in order to maintain the minimum operable LNG level of the high-pressure pump 300, boil-off gas in the high-pressure pump 300 needs to be smoothly discharged. Particularly, the capacity of the suction drum 200 is not sufficient to receive a large amount of boil-off gas generated upon cooldown or initial start-up of the regasification system. In other words, upon cooldown or initial start-up of the regasification system, a large amount of boil-off gas is abruptly supplied to the suction drum 200, causing rapid increase in the internal pressure of the suction drum 200, such that boil-off gas can no longer be supplied to the suction drum 200. As a result, boil-off gas cannot be smoothly discharged from the high-pressure pump 300 to the suction drum 200. As a result, the pressure in the high-pressure pump 300 rises, causing inability of the first boil-off gas discharge line GL1 to deliver LNG from the suction drum 200 to the high-pressure pump 300.

According to the present invention, the liquefied gas regasification system further includes a fourth liquefied gas supply line LL4 directly connecting the supply pump 110 of the LNG storage tank 100 to the high-pressure pump 300, as shown in FIG. 1, such that LNG can be directly supplied from LNG storage tank 100 to the high-pressure pump 300 without passing through the suction drum 200.

The fourth liquefied gas supply line LL4 branches off from the first liquefied gas supply line LL1 and is connected to the high-pressure pump 300 bypassing the suction drum 200, such that LNG can be directly supplied to the high-pressure pump 300, as shown in FIG. 1. In addition, the fourth liquefied gas supply line LL4 may join the second liquefied gas supply line LL2 downstream of the suction drum 200, as shown in FIG. 1, without being limited thereto.

In other words, LNG discharged from the supply pump 110 of the LNG storage tank 100 may be supplied directly to the high-pressure pump 300 along the fourth liquefied gas supply line LL4, or may be supplied to the high-pressure pump 300 through the first liquefied gas supply line LL1, the suction drum 200, and the second liquefied gas supply line LL2.

The fourth liquefied gas supply line LL4 may be provided with a sixth valve V6 for controlling opening/closing of the fourth liquefied gas supply line LL4, and the second liquefied gas supply line LL2 may be provided with a second valve V2 for controlling opening/closing of the second liquefied gas supply line LL2 and the flow rate of LNG through the second liquefied gas supply line LL2. The sixth valve V6 and the second valve V2 may be disposed on the fourth liquefied gas supply line LL4 and the second liquefied gas supply line LL2 upstream of a junction between the fourth liquefied gas supply line LL4 and the second liquefied gas supply line LL2, respectively.

In addition, the regasification system according to the present invention includes a third valve downstream of the junction between the fourth liquefied gas supply line LL4 and the second liquefied gas supply line LL2 to control the flow rate of LNG directly supplied from the supply pump 110 to the high-pressure pump 300 or LNG supplied from the suction drum 200 to the high-pressure pump 300.

In other words, LNG supplied from the LNG storage tank 100 to the high-pressure pump 300 may be LNG that is directly supplied from the supply pump 110 to the high-pressure pump 300 along the fourth liquefied gas supply line LL4, LNG that is supplied to the high-pressure pump 300 through the suction drum 200 along the first liquefied gas supply line LL1, or a mixture thereof.

For example, after the sixth valve V6 is closed, the first valve V1, the second valve V2, and the third valve V3 may be controlled to supply LNG from the LNG storage tank 100 to the high-pressure pump 300 through the supply pump 110 and the suction drum 200.

In addition, after the first valve V1 and the second valve V2 are closed, the sixth valve V6 and the third valve V3 may be controlled such that LNG suctioned and discharged by the supply pump 110 can be supplied directly to the high-pressure pump 300 without passing through the suction drum 200.

Further, all of the first, second, third, and sixth valves V1, V2, V3, V6 may be controlled to supply LNG to the high-pressure pump 300.

According to this embodiment of the present invention, LNG can be smoothly supplied from the supply pump 110 to the high-pressure pump 300 without passing through the suction drum 200 using the fourth liquefied gas supply line LL4, even when LNG cannot be delivered from the suction drum 200 to the high-pressure pump 300 due to excessively high pressure in the high-pressure pump 300.

Particularly, when the internal pressure of the high-pressure pump 300 is too high to secure net positive suction head (NPSH) of the high-pressure pump 300, the sixth valve V6 and the third valve V3 are opened and the first valve V1 and the second valve V2 are closed such that LNG suctioned by the supply pump 110 of the LNG storage tank 100 can be supplied directly to the high-pressure pump 300 along the fourth liquefied gas supply line LL4 bypassing the suction drum 200.

In addition, the regasification system according to the present invention may further include a fifth valve V5 disposed on the first boil-off gas discharge line GL1 to control opening/closing of the first boil-off gas discharge line GL1 and the flow rate of boil-off gas discharged from the high-pressure pump 300 to the suction drum 200 through the first boil-off gas discharge line GL1, wherein the fifth valve V5 may be operatively connected to the first, second, third, and sixth valves V1, V2, V3, V6.

As described above, according to the present invention, since LNG can be smoothly supplied to the high-pressure pump 300, the minimum operable LNG level of the high-pressure pump 300 can be maintained, the pressures in the high-pressure pump 300 and the suction drum 200 can be maintained within a predetermined range, and the pressure in the high-pressure pump 300 can be prevented from being excessively increased, whereby the NPSH of the high-pressure pump 300 can be secured and thus LNG can be smoothly supplied from the high-pressure pump 300 to the vaporizer 400.

Next, a method of operating the liquefied gas regasification system according to one embodiment will be described with reference to FIG. 1. According to this embodiment, LNG to be regasified and supplied to a gas consumer is discharged from the LNG storage tank 100 by the supply pump 110 disposed in the LNG storage tank 100, wherein LNG having been discharged by the supply pump 110 may be supplied to the gas consumer in two operation modes described hereinafter.

<First Operation Mode>

First, LNG is discharged by the supply pump 110 and then supplied to the suction drum 200 through the first liquefied gas supply line LL1 at a flow rate required by the gas consumer. LNG received by the suction drum 200 is supplied to the high-pressure pump 300 through the second liquefied gas supply line LL2. Once the level of LNG in the high-pressure pump 300 reaches a predetermined value, the high-pressure pump 300 compresses LNG to high pressure, i.e., a pressure required by the gas consumer, and supplies the compressed LNG to the vaporizer 400 through the third liquefied gas supply line LL3. The vaporizer 400 vaporizes LNG and supplies the vaporized LNG to the gas consumer.

Here, boil-off gas naturally generated in the high-pressure pump 300 may be discharged to the suction drum 200 through the first boil-off gas discharge line GL1, and boil-off gas returned to the suction drum 200 may be at least partially recondensed by LNG supplied to the suction drum 200 through the first liquefied gas supply line LL1.

Thus, the suction drum 200 according to this embodiment may also serve as a recondenser. Boil-off gas having been recondensed by the suction drum 200 is supplied to the high-pressure pump 300 along with LNG supplied to the high-pressure pump 300 via the second liquefied gas supply line LL2.

When maintenance is required due to failure of the suction drum 200 or the like during the operation mode in which LNG is supplied to a gas consumer using the supply pump 110, the suction drum 200, the high-pressure pump 300, and the vaporizer 400, it is necessary to shut off gas supply to the gas consumer. However, according to this embodiment, even when the suction drum 200 is not available, the regasification system may be switched to a second operation mode described below such that a required amount of gas can be supplied to the gas consumer without system shutdown.

LNG to be supplied from the suction drum 200 to the high-pressure pump 300 is delivered by head of LNG in the suction drum 200. For example, when return of boil-off gas from the high-pressure pump 300 to the suction drum 200 cannot be smoothly achieved due to sudden generation of a large amount of boil-off gas in the high-pressure pump 300 upon start-up of the regasification system, the pressure in the high-pressure pump 300 rises, causing the inability to supply LNG from the suction drum 200 to the high-pressure pump 300. According to the present invention, such a problem can be solved by executing the second operation mode described below.

<Second Operation Mode>

In the second operation mode according to this embodiment, LNG stored in the storage tank 100 is discharged by the supply pump 110 and then directly supplied to the high-pressure pump 300 along the fourth liquefied gas supply line LL4 without passing through the suction drum 200.

As in the first operation mode, the high-pressure pump 300 compresses LNG and supplies the compressed LNG to the vaporizer 400, and the vaporizer 400 regasifies LNG and supplies the regasified LNG to a gas consumer.

Although, also in the second operation mode, boil-off gas generated in the high-pressure pump 300 is returned to the suction drum 200 along the first boil-off gas discharge line GL1, some of LNG discharged using the supply pump 110 is supplied to the suction drum 200 along the first liquefied gas supply line LL1 to recondense boil-off gas returned to the suction drum 200 and the rest of the LNG is supplied to the high-pressure pump 300 along the fourth liquefied gas supply line LL4.

When LNG supplied to recondense boil-off gas and boil-off gas recondensed into a liquid state are accumulated in the suction drum 200, the second valve V2 of the second liquefied gas supply line LL2 may be opened to supply the accumulated LNG and the recondensed boil-off gas to the high-pressure pump 300.

When the second operation mode is executed such that LNG is supplied from the supply pump 110 to the high-pressure pump 300 along the fourth liquefied gas supply line LL4 without passing through the suction drum 200, gas can be continuously supplied to the gas consumer without system shutdown even during maintenance of the suction drum 200.

In addition, since the pressure of LNG suctioned by the supply pump 110 of the storage tank 100 is higher than the pressure of supplying LNG to the high-pressure pump 300 using head of LNG in the suction drum 200, when the second operation mode is executed such that LNG is directly supplied from the supply pump 110 to the high-pressure pump 300, it is possible to overcome the inability to supply LNG from the suction drum 200 to the high-pressure pump 300 due to pressure increase in the high-pressure pump 300, and the net positive suction head (NPSH) of the high-pressure pump 300 can be reliably secured.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

1. A liquefied gas regasification system comprising:
a supply pump discharging liquefied gas from a liquefied gas storage tank;
a high-pressure pump receiving liquefied gas from the liquefied gas storage tank and compressing the liquefied gas; and
a fourth liquefied gas supply line connecting the supply pump to the high-pressure pump,
wherein the supply pump is directly connected to the high-pressure pump through the fourth liquefied gas supply line, such that liquefied gas is directly supplied to the high-pressure pump by the supply pump.

2. The liquefied gas regasification system according to claim 1, further comprising:
a suction drum recovering boil-off gas generated in the high-pressure pump; and
a first boil-off gas discharge line connecting the high-pressure pump and the suction drum, such that boil-off gas generated in the high-pressure pump is discharged to the suction drum through the first boil-off gas discharge line.

3. The liquefied gas regasification system according to claim 2, further comprising:
a second liquefied gas supply line connecting the suction drum to the high-pressure pump; and
a sixth valve disposed on the second liquefied gas supply line and controlled based on a measured value of level of LNG in the suction drum, such that liquid accumulated in the suction drum is supplied to the high-pressure pump.

4. The liquefied gas regasification system according to claim 3, further comprising:
a first liquefied gas supply line connecting the supply pump to the suction drum, such that liquefied gas suctioned by the supply pump is supplied to the suction drum.

5. The liquefied gas regasification system according to claim 4, further comprising:
a vaporizer vaporizing liquefied gas compressed by the high-pressure pump and supplying the vaporized liquefied gas to a gas consumer.

6. A method of operating a liquefied gas regasification system, comprising:
supplying liquefied gas from a liquefied gas storage tank to a high-pressure pump and compressing, by the high-pressure pump, the liquefied gas; and
supplying the compressed liquefied gas to a vaporizer, vaporizing, by the vaporizer, the compressed liquefied gas, and supplying the vaporized liquefied gas to a gas consumer,
wherein liquefied gas is supplied directly to the high-pressure pump using a supply pump in the liquefied gas storage tank along a line directly connecting the supply pump to the high-pressure pump.

7. The method according to claim 6, wherein boil-off gas generated in the high-pressure pump is discharged to a suction drum, and liquefied gas is supplied to the suction drum using the supply pump, such that liquid accumulated in the suction drum is supplied to the high-pressure pump.

8. The method according to claim 7, wherein a portion of liquefied gas supplied using the supply pump is delivered to the suction drum to recondense boil-off gas returned to the suction drum, and the rest of the liquefied gas is delivered to the high-pressure pump along a line directly connecting the supply pump to the high-pressure pump.

9. The method according to claim 8, wherein the liquid supplied from the suction drum to the high-pressure pump is delivered by head of liquid in the suction drum, and the liquefied gas supplied from the supply pump to the high-pressure pump is delivered by pressure of liquefied gas compressed by the supply pump.

10. The method according to claim 8, wherein, when a level of liquid in the suction drum is higher than or equal to a predetermined value, a line connecting the suction drum to the high-pressure pump is opened.
